(19) United States
(12) Patent Application Publication
(10) Pub. No.: US 2022/0401767 A1
(43) Pub. Date: Dec. 22, 2022

(54) FIRE BLOCK COMPONENT AND ASSEMBLY

(71) Applicant: CALIFORNIA EXPANDED METAL PRODUCTS COMPANY, City of Industry, CA (US)

(72) Inventor: Donald Anthony Pilz, Livermore, CA (US)

(21) Appl. No.: 17/822,091

(22) Filed: Aug. 24, 2022

Related U.S. Application Data
(63) Continuation-in-part of application No. 17/668,629, filed on Feb. 10, 2022.
(60) Provisional application No. 63/148,082, filed on Feb. 10, 2021.
(60) Provisional application No. 63/202,939, filed on Jun. 30, 2021.

(51) Int. Cl. A62C 2/06; E04B 1/94

(52) U.S. Cl. CPC A62C 2/065; E04B 1/948

(57) ABSTRACT

A fire-resistant strip for providing a fire-rated seal to a construction gap or joint includes an intumescent material layer configured to expand in response to a temperature above a threshold temperature and at least one heat resistant material layer made of or comprising a material having a melting temperature above the threshold temperature, such as a fiberglass material. The at least one heat resistant material layer covers the intumescent material layer. At least one adhesive layer is configured to secure the fire-resistant strip to a building structure or structures defining the construction gap or joint.

### INCORPORATION BY REFERENCE

This application is a continuation-in-part of U.S. patent application Ser. No. 17/668,629, filed Feb. 10, 2022, pending, which claims priority to U.S. Provisional Application Nos. 63/202,939, filed Jun. 30, 2021, and 63/148,082, filed Feb. 10, 2021, both expired, the entireties of which are incorporated by reference herein and made a part of the present disclosure.

### BACKGROUND

### Field

The disclosure relates to fire-rated construction components and related assemblies. In particular, the disclosure relates to multi-layer fire-rated strips configured to provide a fire-rated seal of a construction gap or joint and assemblies including such multi-layer fire-rated strips.

### Description of the Related Art

The 2012 International Building Code was revised to include special inspections for fire-rated building joints. These inspections are a combination of visual and destructive testing. A common method of providing a fire-rated building joint is to use a fire sealant caulk at the building gap or joint. However, fire sealant is difficult to install and difficult to inspect. In addition, the fire testing standard UL-2079 “Tests for Fire Resistance of Building Joint Systems” that is used to certify the fire resistance of the building joint has also been revised.

In particular, the testing protocol for UL-2079 5^{th} edition has changed the location in which the thermal couplers or thermocouples (TC) are placed on the unexposed side of the fire test. Prior to the 5^{th} edition, the 4^{th} edition allowed the TC's to be located only on the surface of the drywall and not directly on the joint fill material. Once the TC's were required to be placed on the joint fill material in the 5^{th} edition, some prior art intumescent products were unable to pass the UL-2079 test. As a result, some UL certified joint systems were no longer valid after this new edition was implemented.

For these reasons, many firestop manufacturers are looking for alternative ways to provide firestopping at drywall building joints without using fire sealant and that would pass the new testing requirements. Intumescent alone, at least in some configurations, is not sufficient to inhibit the transfer of heat across the wall to a sufficient extent to pass the UL-2079 test when the TC is placed directly on the intumescent strip.

### SUMMARY

The systems, methods and devices described herein have innovative aspects, no single one of which is indispensable or solely responsible for their desirable attributes. Without limiting the scope of the claims, some of the advantageous features will now be summarized.

An aspect of the present disclosure involves a fire-resistant strip for providing a fire-rated seal to a construction gap or joint. The strip includes an intumescent material layer configured to expand in response to a temperature above a threshold temperature. The strip also includes at least one heat resistant material layer made of or comprising a material having a melting temperature above the threshold temperature. The at least one heat resistant material layer covers the intumescent material layer. At least one adhesive layer is configured to secure the fire-resistant strip to a building structure or structures defining the construction gap or joint.

In some configurations, the at least one heat resistant material layer comprises a first heat resistant material layer and a second heat resistant material layer.

In some configurations, the intumescent material layer is positioned between the first heat resistant material layer and the second heat resistant material layer.

In some configurations, the at least one heat resistant material layer comprises a woven fiberglass material, a fiberglass chop strand mat material, or a foil material.

In some configurations, further comprising a cover layer made of or comprising foil, vinyl or fiberglass.

In some configurations, the cover layer and/or the at least one heat resistant material layer is wider than the intumescent layer to form side portions of the fire-resistant strip.

In some configurations, the side portions include adhesive.

In some configurations, the intumescent material layer is positioned between the cover layer and the at least one heat resistant material layer.

In some configurations, the adhesive layer is a double-sided foam or adhesive film tape.

In some configurations, the at least one heat resistant material layer is wider than the intumescent layer to form side portions of the fire-resistant strip.

In some configurations, the at least one adhesive layer has a width that is equal to or less than a width of one or both of the intumescent material layer and the at least one heat resistant material.

In some configurations, the width of the at least one adhesive layer is equal to or less than two-thirds of the width of one or both of the intumescent material layer and the at least one heat resistant material.

In some configurations, the width of the at least one adhesive layer is equal to or less than one-half of the width of one or both of the intumescent material layer and the at least one heat resistant material.

An aspect of the present disclosure involves a fire-resistant strip for providing a fire-rated seal to a construction gap or joint. The strip includes an adhesive layer and an intumescent strip comprising an intumescent material that expands in response to a temperature above a threshold temperature. The adhesive layer includes adhesive portions located on each side of the intumescent strip. The intumescent strip does not include an adhesive layer such that the intumescent strip is not directly attached to a building structure to which the fire block tape component is attached.

In some configurations, a cover layer is slightly elastic or stretchable to be able to stretch in response to expansion of the intumescent strip.

In some configurations, the cover layer has heat resistant properties.

In some configurations, the cover layer is a paintable material.

In some configurations, the cover layer includes or is made from, or an additional layer is provided that includes or is made from, a material that can properly receive joint compound without cracking the joint compound.

In some configurations, a foam strip is positioned side-by-side with the intumescent strip.

In some configurations, the foam strip comprises an open or closed cell material.

In some configurations, the cover layer is or comprises a foil material.

In some configurations, further comprising a foil layer backing the intumescent strip.

An aspect of the present disclosure involves a fire-resistant strip for providing a fire-rated seal to a construction gap or joint. The strip includes an intumescent material layer configured to expand in response to a temperature above a threshold temperature. The strip also includes a heat resistant material layer and an adhesive layer configured to secure the fire-resistant strip to one or more construction components. The adhesive layer comprises adhesive portions located on each side of the fire-resistant strip.

In some configurations, the heat resistant material layer comprises a vinyl, foil, or fiberglass material.

In some configurations, the heat resistant material layer is a paintable material.

In some configurations, an outer surface of the fire-resistant strip comprises a material that can properly receive joint compound without cracking the joint compound.

In some configurations, the heat resistant material layer is stretchable.

In some configurations, the strip includes a foam material strip.

In some configurations, the foam material strip is located adjacent the intumescent strip.

An aspect of the present disclosure involves a fire-resistant strip for providing a fire-rated seal to a construction gap or joint. The strip includes an intumescent material layer configured to expand in response to a temperature above a threshold temperature. The strip also includes at least one heat resistant material layer made of or comprising a fiberglass material having a melting temperature above the threshold temperature. The at least one heat resistant material layer covers the intumescent material layer. At least one adhesive layer is configured to secure the fire-resistant strip to a building structure or structures defining the construction gap or joint.

An aspect of the present disclosure involves an assembly including any of the aforementioned fire-resistant strips coupled to a building structure at a gap or junction defined by the building structure.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a sectional view of a fire-resistant strip for providing a fire-rated seal to a construction gap or joint.

FIG. 2 is a sectional view of another fire-resistant strip.

FIG. 3 is a sectional view of the fire-resistant strip of FIG. 2 installed in a head-of-wall assembly.

FIG. 4 is a sectional view of yet another fire-resistant strip.

FIG. 5 is a sectional view of another fire-resistant strip in which all of the layers have the same width.

FIG. 6 is a sectional view of the fire-resistant strip of FIG. 5 installed in a head-of-wall assembly.

FIG. 7 is a sectional view of another version of a fire-resistant strip.

FIG. 8 is a sectional view of the fire-resistant strip of FIG. 7 installed on a header track.

FIG. 9 is a wall assembly that incorporates the header track of FIG. 8 with the fire-resistant strip of FIG. 7.

FIG. 10 is a wall assembly that incorporates a fire-resistant strip in the head-of-wall deflection gap.

FIG. 11 is a sectional view of a fire-resistant strip with a cover layer that has a greater width than the remaining layers.

FIG. 12 is a sectional view of a fire-resistant strip with an adhesive layer that has a width that is less than a width of an intumescent layer and a cover layer.

FIG. 13 is a sectional view of a fire-resistant strip in which all of the layers have the same width.

FIG. 14 is a sectional view of another fire-resistant strip.

FIG. 15 is a sectional view of a wall assembly incorporating the fire-resistant strip of FIG. 14.

FIG. 16 is a sectional view of a wall assembly incorporating an intumescent material strip.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The present inventor believes a reason certain prior art products could not pass the fire test portion of UL-2079 is because the intumescent was either directly adhesively attached to the header track or rigidly secured in close contact with the header track or framing member. This close proximity between the intumescent strip and the framing member allowed the intumescent to expand too quickly on the unexposed side of the fire test. Once the intumescent strip begins to expand on the unexposed side, it is not long until the TC will detect a temperature that exceeds the maximum allowed temperature on the unexposed side. Intumescent strips are a great way to inhibit or prevent the passage of heat and flame through the building joint of a wall assembly. However, at least some intumescent strips have an ignition flash point that happens right before the expansion starts. This flash point is just hot enough to exceed the maximum allowed temperature of the UL-2079 test requirement.

The multi-layer fire-resistant strips disclosed herein provide the protection needed to prevent the thermal passage outlined in UL-2079 5th edition by utilizing one or more high heat resistant materials in combination with an intumescent or fire-resistant material. In some configurations, a material containing fiberglass, such as a woven fiberglass tape, fiberglass mat, or fiberglass chop strand mat tape, is utilized in combination with an intumescent material. Additional materials may also be used. Woven fiberglass tape, for example, can resist heat up to 1022 degrees Fahrenheit (° F.) and remain cool to the touch or at least cool enough to pass the UL-2079 test requirement after being exposed to high temperatures. When a fiberglass material is combined by layering, stacking, or adhering to an intumescent strip or another fire-resistant material, it will create a suitable fire block material for fire-rated drywall building joints. In other configurations, the high heat resistant material is a high heat polymer tape or foil tape. The high heat polymer tape or foil tape is utilized in combination with an intumescent material. Additional materials may also be used. This material combination also provides a suitable fire block material for fire-rated drywall building joints.

The fire-rated components disclosed herein can be elongated strips having any desirable length, such as 4, 8, 10, 20, 50, 100 or more feet. The elongated strips can be sold as a component. For example, the elongated strips can be provided as a strip or a roll. Such arrangements can allow installation in the field. Alternatively, the elongated strips can be installed onto a building component in the factory and sold as a composite product ready for installation.

The fire-rated strips can have a consistent cross-sectional shape and/or arrangement along the length of the strip. The disclosed strips may be illustrated in schematic form to show the different layers that make up the strip. The layers may be shown with spaces therebetween to allow the structure of the multi-layer fire-rated strips to be clearly disclosed. Typically, the layers are in contact with one another and no space is present in the finished product.

The relative or absolute thickness of the various layers may not be to scale unless otherwise indicated. In general, the thickness of any particular layer can be selected in accordance with the desired end properties of the fire-rated strip. For example, a thickness of the intumescent material or other fire-rated or fire-resistant material may be selected in view of a width of the intumescent material to provide a desired amount of fire-blocking or resistant to heat transfer and/or a desired amount of coverage upon expansion. A thickness of the high heat resistant material may be selected to provide a desired amount of resistance to heat transfer. A thickness of the adhesive layers may be selected, in view of the type of adhesive used, to provide a desired amount of adhesion. In some configurations, the intumescent material (or other fire-rated or fire-resistant material) layer may have the greatest thickness of the provided layers. In some configurations, the high heat resistance material may be the second thickest material layer.

As used herein, an intumescent material is a material or materials that expand in response to a threshold temperature to provide a heat insulating layer. In some cases, the threshold temperature can be about 375 degrees Fahrenheit (° F.). Intumescent materials may be a polymer material that provides a thermal and physical barrier to the underlying substrate and thus block the high temperatures and rapid flame spread of fires. In some materials, during exposure to a fire, the temperature within the intumescent material rises, causing melting of the thermoplastic matrix. When the temperature corresponds to an appropriate value for the viscosity of the melt, an endothermic gas-producing chemical reaction is triggered. The gas collects in small bubbles, causing the material to foam. Solidification into a thick multicellular char provides an insulating layer that slows down the transport of heat and reduces the amount of material that becomes involved in the fire. In some configurations, other types of similar fire-blocking materials may be used. The embodiments that include an intumescent material or intumescent layer can be replaced with a similar embodiment that includes another fire-blocking material in place of the intumescent material.

As discussed above, as used herein, a high heat resistant material is a material or materials that have a high melting temperature and are effective at inhibiting the transfer of heat through the material. The melting temperature should be higher than the activation temperature of the intumescent material in the strip. In some cases, the melting temperature is substantially higher than the activation temperature of the intumescent material. Examples of suitable high heat resistant materials include fiber-glass-containing materials, such as a woven fiberglass tape, fiberglass mat, or fiberglass chop strand mat tape. An example of a suitable woven fiberglass tape is sold by Advanced Polymer Tape Inc. of Newmarket, Canada. An example of a suitable fiberglass mat tape is sold under the brand name FibaFuse® sold by Compagnie de Saint-Gobain S.A. of La Defense, France. An example of a suitable fiberglass chop strand mat tape is sold by Fibre Glast Developments Corp. of Brookville, Ohio. Other suitable high heat resistant materials include high heat polymer tape or high heat foil tape. An example of a suitable high heat polymer tape is Kapton polyimide tape sold by Advanced Polymer Tape Inc. of Newmarket, Canada. An example of a suitable high heat foil tape is an aluminum foil tape sold under the brand name VENTURE TAPE™ ASJ Facing Tape by 3M of Maplewood, Minn. In some embodiments, the fiberglass tape or fiberglass material is uncoated. That is, the fiberglass tape or material includes glass fibers and a resin but no additional fireproofing coatings, additives or layers, such as hydrated mineral coatings (e.g., vermiculite). Such coatings are often used as a fireproofing material. The present inventor has discovered that fiberglass material used in combination with intumescent materials provides satisfactory performance to pass the UL-2079 test requirement in the absence of additional coatings or additives, such as vermiculite or other similar fireproofing coatings/additives. Such unnecessary coatings/additives add cost and undesired thickness to the fire-resistant strip. Therefore, as used herein, uncoated fiberglass tape or fiberglass material means a fiberglass tape or other fiberglass material that does not include a further coating, additives or layer(s) of a fireproofing material. Such uncoated materials may include an adhesive layer as well as a removable protective covering over the adhesive layer. Although referred to as “tape” herein, these layers may, but do not necessarily incorporate an adhesive material. That is, a “tape” is a thin material layer that may or may not be self-adhering. The embodiments that include one type of high heat resistant material can be replaced with a similar embodiment that includes another type of high heat resistant material instead.

As used herein, an adhesive material or adhesive layer is a material or layer that adheres to another material and, particularly, other layers of the strip and/or the construction component on which the strip is configured to be placed. Adhesive materials can be a composite that includes other materials. For example, an adhesive layer can be a double-sided foam tape (e.g., P4200 Series polyethylene foam tape from Pres-On Corporation of Bolingbrook, Ill.) or a double-sided adhesive film (e.g., Tesa® 4965 Original from tesa tape, inc. of Charlotte, N.C.). Such products are readily available and are convenient to create the multi-layer arrangements disclosed herein. The addition of the foam or film backing material may be simply acceptable within the arrangement or may add benefit to the overall arrangement. However, the adhesive material or adhesive layer can also be solely an adhesive material without any type of backing material. The embodiments that include one type of adhesive material can be replaced with a similar embodiment that includes another type of adhesive material instead.

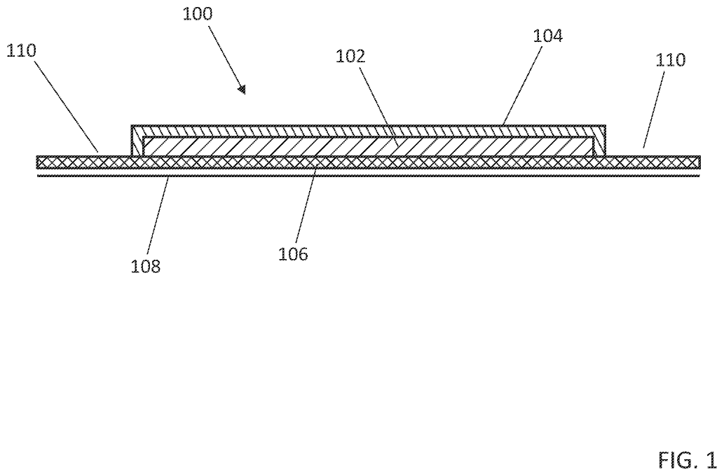

FIG. 1 is a sectional view of an elongate fire-resistant strip 100 configured to extend along a gap or joint in a building. The strip 100 of FIG. 1 includes an intumescent material layer 102 and a high heat resistant material layer. In the illustrated arrangement, the intumescent material layer 102 is encased with a first high heat resistant material layer 104 on one side and a second high heat resistant material layer 106 on the other side of the intumescent material layer 102. In the illustrated arrangement, the high heat resistant material layer is a woven fiberglass material, which may be a woven fiberglass tape.

In the illustrated arrangement, one or both of the first high heat resistant material layer 104 on one side and the second high heat resistant material layer 106 have a width that is greater than a width of the intumescent material layer 102. The first high heat resistant material layer 104 can cover only the intumescent material layer 102 or can cover both the intumescent material layer 102 and all or part of the side portions 110 of the second high heat resistant material layer 106 outward of the intumescent material layer 102.

At least the two sides of the second high heat resistant material layer 106 include an adhesive material on the surface opposite the intumescent material layer 102 or the bottom surface in FIG. 1. In the illustrated arrangement, the high heat resistant material layers are a woven fiberglass tape, which includes an integrated adhesive material. However, in other arrangements, the adhesive material could be a discrete layer from the high heat resistant material layers. A release paper 108 can be provided over the adhesive material to allow the fire blocking strip 100 to be stored and/or rolled prior to use. The release paper 108 can be removed to allow the fire blocking strip 100 to be adhered to the desired construction component using the adhesive material. In some configurations, the fire blocking strip 100 is configured to be adhered to a framing member, such as a header track, at both the leg and the web or the leg and the overhead structure. In some configurations, a greater portion or an entirety of the bottom surface can include an adhesive material.

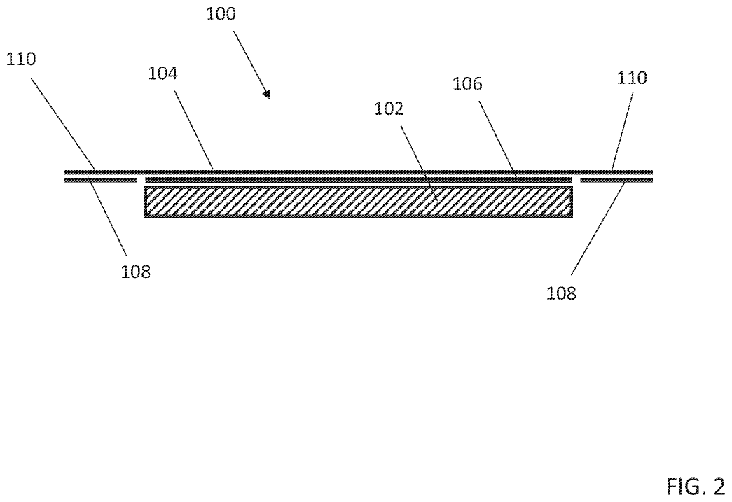

FIG. 2 is a sectional view of another elongate fire-resistant strip 100 configured to extend along a gap or joint in a building. The strip 100 of FIG. 2 includes an intumescent material layer 102, a protective cover layer 104 and a high heat resistant material layer 106. The protective cover layer 104 can be a high heat resistant material, such as foil, polymer, woven fiberglass tape, fiberglass mat, or fiberglass chop strand mat tape. Alternatively, the cover layer 104 can be a vinyl material. The protective cover layer 104 can have an adhesive material (not separately shown) on the interior side or bottom side in the illustrated orientation. The high heat resistant material layer 106, which can be a woven fiberglass tape or a fiberglass chop strand mat tape. The high heat resistant material layer 106 can be adhered to the center portion of the cover layer 104 between the cover layer 104 and the intumescent material layer 102. The cover layer 104 can have side portions 110 that extend beyond one or both of the intumescent material layer 102 and the high heat resistant material layer 106. The sides of the protective cover layer 104 can include an adhesive material and a release paper 108 to protect the adhesive material prior to use. In some configurations, the bottom surface of the intumescent material layer 102 could also include an adhesive material.

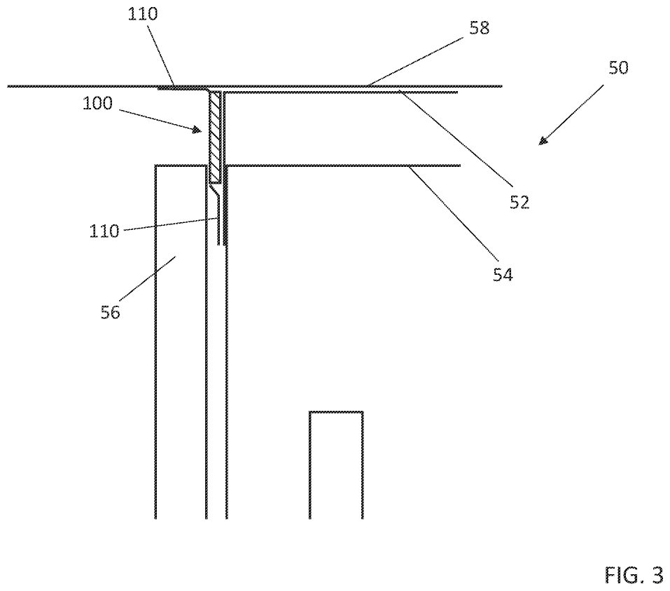

FIG. 3 is a sectional view of a wall assembly 50 using the fire-resistant strip 100 of FIG. 2 at a head-of-wall joint. The wall assembly 50 includes a framing member, which is a header track 52 in the illustrated arrangement. The wall assembly 50 also includes a plurality of studs 54 (one shown) received within the header track 52, and a wallboard or drywall 56 coupled to the studs 54. An upper edge of the drywall 56 overlaps the header track 52. The header track 52 is secured to an overhead structure 58. A footer track (not shown) receives the lower ends of the studs 54. The side portions 110 of the fire-resistant strip 100 are adhered to a respective one of the framing member or header track 52 and the overhead structure 58. In the illustrated arrangement, the intumescent material layer 102 is directly facing the framing member or header track 52. The high heat resistant material layer 106, which can be a woven fiberglass layer, is sandwiched between the intumescent material layer 102 and the protective cover layer 104. In the illustrated arrangement, the interior surface of the drywall 56 is in direct contact with the protective cover layer 104 of the fire-resistant strip 100. The fire-resistant strip 100 of FIG. 1, or other fire-resistant strips disclosed herein, could similarly be positioned within the wall assembly 50.

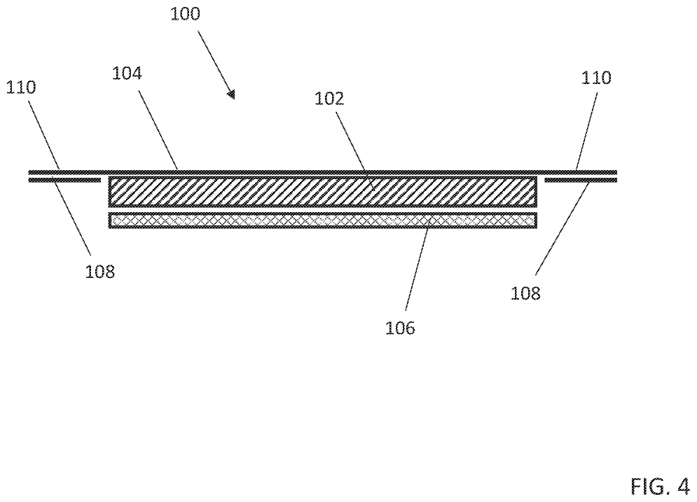

FIG. 4 is a sectional view of another fire-resistant strip 100. In the illustrated arrangement, the outer protective layer 104 is the widest layer allowing the sides or free edges 110 to be located to the outside of the intumescent material layer 102 and the high heat resistant material layer 106. The protective layer 104 can be made from or comprise foil or vinyl, or woven fiberglass with an adhesive material (not separately shown) on the interior side or bottom side in the illustrated orientation. The intumescent material layer 102 is sandwiched between the protective cover layer 104 and the high heat resistant material layer 106, which can be a layer of woven fiberglass, for example. The high heat resistant material layer 106 can have adhesive material on each side so as to form a double-sided tape. One side can adhere to the intumescent material layer 102 and one side can adhere to the building structure to be protected or that which forms or is adjacent to a gap or joint to be protected. The free edges 110 of the protective cover layer 104 have a release paper 108 to protect the adhesive material on either side of the intumescent material strip 102 and the high heat resistant material layer 106.

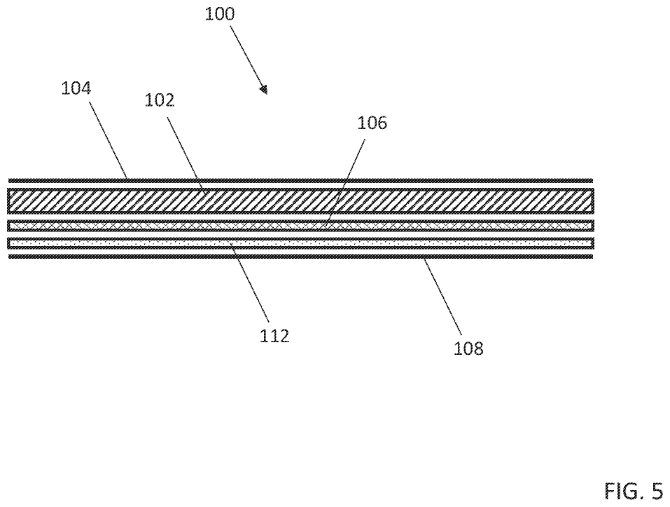

FIG. 5 is a sectional view of another fire-resistant strip 100, which includes five layers. In the illustrated arrangement, all of the layers are the same width. However, in other arrangements, the widths could vary to create side portions similar to the side portions 110 of the strips 110 of FIGS. 1, 2 and 4. The protective layer 104 is directly adhered to the intumescent material layer 102. The protective layer 104 can be made from or comprise foil, vinyl, fiberglass mat, or woven fiberglass with an adhesive material (not separately shown). The intumescent material layer 102 is positioned between the protective layer 104 on one side and the high heat resistant material layer 106, which can be a fiberglass mat, a woven fiberglass layer, on the other side. An adhesive layer 112 is adhered to the bottom surface of the high heat resistant material layer 106. In the illustrated arrangement, the adhesive layer 112 is a double-sided foam tape. However, the adhesive layer 112 could also be a double-sided adhesive film or another suitable adhesive material or material(s). The release paper 108 protects the adhesive layer 112 until the strip 100 is ready to be installed.

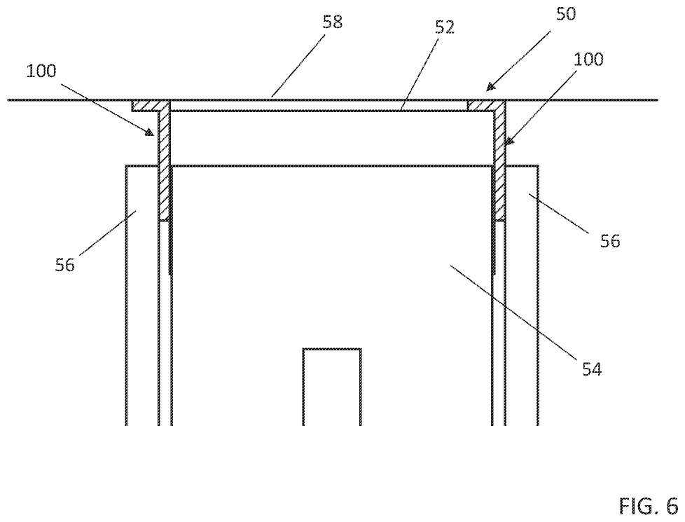

FIG. 6 is a sectional view of a wall assembly 50 with the fire-resistant strip 100 of FIG. 5 adhered in two optional arrangements to structures or components of the head of wall assembly 50. On the right side, the fire-resistant strip 100 is positioned (e.g., adhered) along the leg and web of the framing member or header track 52 such that a portion of the strip 100 is positioned between the header track 52 and the overhead structure 58. Such an arrangement can help secure the strip 100 in place, but requires the strip 100 to be applied to the header track 52 prior to the header track 52 being attached to the overhead structure 58. On the left side, the fire-resistant strip 100 is positioned (e.g., adhered) along the leg of the framing member or header track 52 and overlapping onto the overhead structure 58. Such an arrangement can allow the header track 52 to be positioned more tightly against the overhead structure 58 and allows the strip 100 to be applied after the header track 52 is secured to the overhead structure 58. The fire-resistant strips 100 can be positioned in the same orientation on each side of the wall assembly 50 or differently on each side of the wall assembly 50.

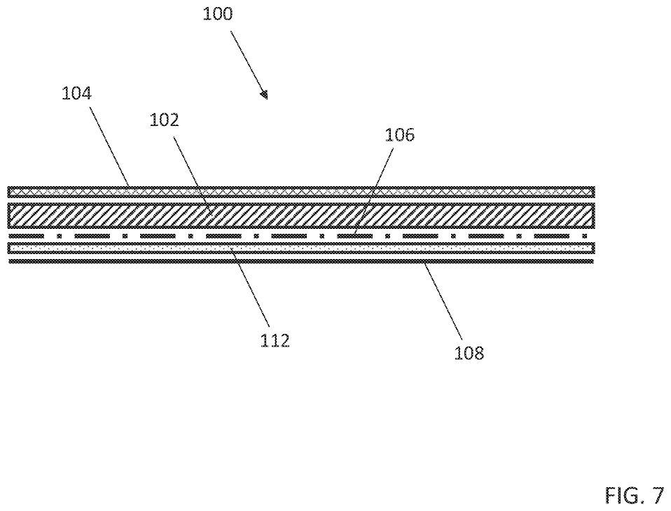

FIG. 7 is a sectional view of another elongate fire-resistant strip 100 configured to extend along a gap or joint in a building. The strip 100 of FIG. 7 includes an intumescent material layer 102, a protective cover layer 104 and a high heat resistant material layer 106. In the illustrated arrangement, all of the layers are the same width. However, in other arrangements, the widths could vary to create side portions similar to the side portions 110 of the strips 110 of FIGS. 1, 2 and 4. The protective layer 104 is directly adhered to the intumescent material layer 102 and can be made from or comprise foil, vinyl, film, woven fiberglass, or fiberglass mat with an adhesive material (not separately shown). The intumescent material layer 102 is positioned between the protective layer 104 and an adhesive layer 112. An optional high heat resistant material layer 106, which can be a woven fiberglass layer, can be provided between the intumescent material layer 102 and the adhesive layer 112. For example, if the protective cover layer 104 is a vinyl or film material, the high heat resistant material layer 106 may be desirable to increase the resistance to heat transfer through the strip 100. In the illustrated arrangement, the adhesive layer 112 is a double-sided foam tape. However, the adhesive layer 112 could also be a double-sided adhesive film or another suitable adhesive material or material(s). The release paper 108 protects the adhesive layer 112 until the strip 100 is ready to be installed.

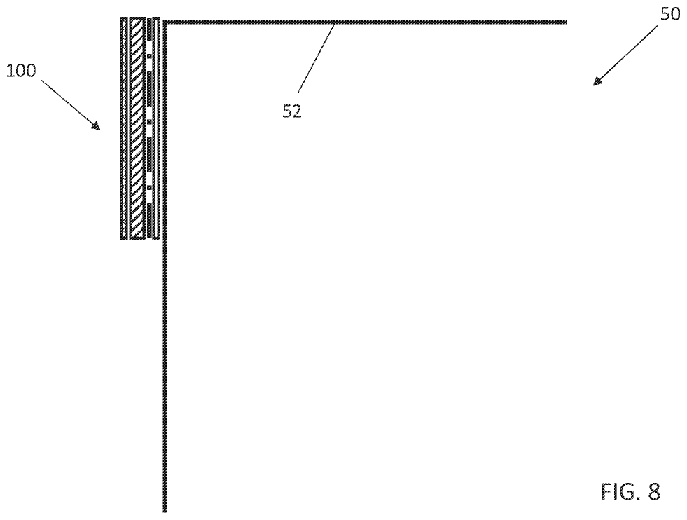

FIG. 8 is a sectional view of a wall assembly 50 with the fire-resistant strip 100 of FIG. 7 adhered to structures or components of the wall assembly 50. In particular, the strip 100 is adhered to the header track 52. For convenience, only the header track 52 of the wall assembly 50 is illustrated in FIG. 8. However, the wall assembly 50 can have the same or similar components as illustrated in FIG. 3 or 6. The strip 100 is adhered to an upper corner of the header track 52. In the illustrated arrangement, the release paper 108 has been removed and the strip 100 is adhered to the header track 52 by the adhesive layer 112 with the protective cover layer 104 facing outward.

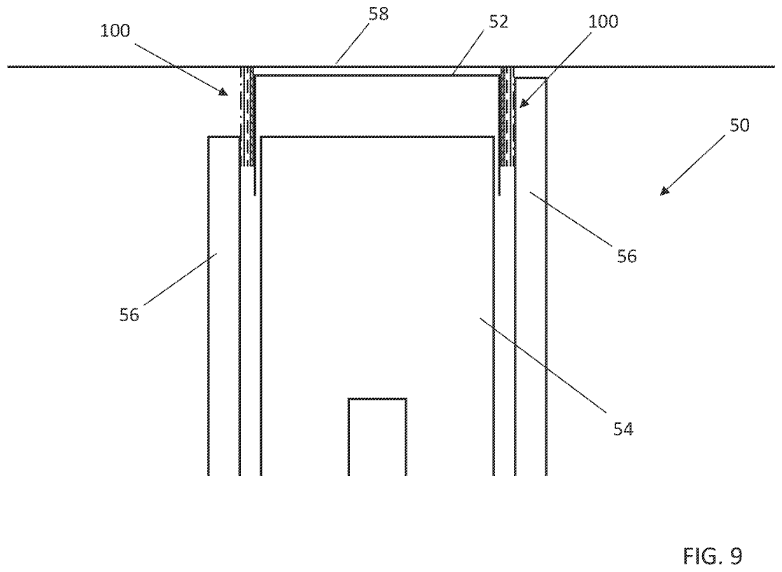

In some configurations, as illustrated in FIG. 9, one of the strips 100 is provided on each side of the header track 52. The protective cover layer 104 provides protection to the strip 100 from movement of the wallboard or drywall 56. For example, the left side illustrates the wallboard or drywall 56 in a relatively lower position relative to the overhead structure 58. This position can be referred to as an open position that creates an open joint or deflection gap. The right side illustrates the wallboard or drywall 56 in a relatively higher position relative to the overhead structure 58. This position can be referred to as a closed position that creates a closed joint in which the deflection gap is reduced or eliminated. Relative movement between the overhead structure 58 and the wallboard or drywall 56 (and studs 54) can occur as a result of seismic forces or loading of the overhead structure.

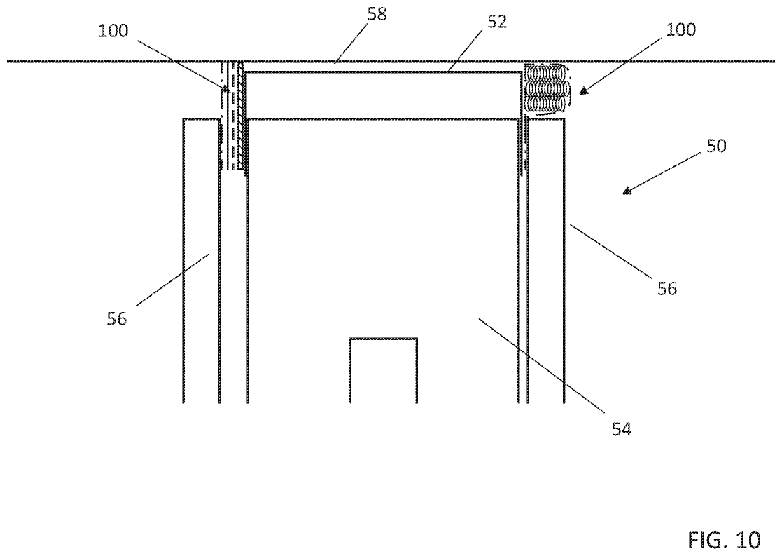

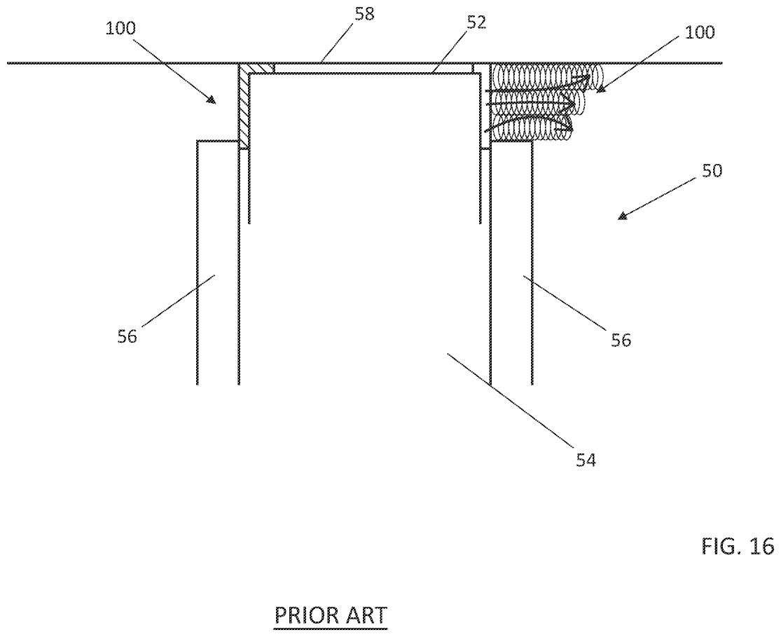

FIG. 16 illustrates a wall assembly 50 having an intumescent strip 60 on each side of the header track 52. The illustrated intumescent strip 60 may be similar to the original FAS Track product sold by CEMCO, the Clark Dietrich Blazeframe product or the arrangement shown in, for example, FIG. 10A of Applicant's U.S. Pat. No. 8,087,205. Such prior art arrangements rely on the intumescent strip 60 being contained at at least one of the two free ends of the intumescent strip 60. In the arrangement of U.S. Pat. No. 8,087,205 patent, one free end of the intumescent strip 60 is pinched between the overhead structure 58 and the header track 52. In the Blazeframe product, one free end of the intumescent strip 60 is pinched between between the leg of the header track 52 and the wallboard or drywall 56. The illustrated intumescent strip 60 is pinched on each end, similar to the original FAS Track product. This arrangement leaves a center part of the intumescent strip 60 unconfined and free to expand, as illustrated on the right side of the wall assembly 50 in FIG. 16.

FIG. 10 illustrates the wall assembly 50 of FIG. 9 having the strips 100 of the present disclosure with the wallboard or drywall 56 in the open position. The present inventor has determined that it is beneficial to contain the intumescent material layer 102 to confine the direction and/or amount of the expanding intumescent material. Placing a layer of the protective cover layer 104, the high heat resistant material layer 106, or both, under, over, or both over and under the intumescent material layer 102 will contain the expansion of the intumescent material and keep it near the desired location for fire protection. Such layers 104 and/or 106 will contain the expanding intumescent material behind the protective layer 104 and/or 106 and prevent free flow expansion of the intumescent material. Such an arrangement can also keep the surface of the strip 100 at a lower temperature in comparison to a strip that is constructed solely of intumescent material or intumescent tape (which often includes a thin bond breaking film layer), which aids in passing the UL-2079 fire test. The present inventor believes that fiber-glass-containing materials (e.g., such as a woven fiberglass tape or fiberglass chop strand mat tape), high heat polymer tape, and high heat foil tape provide advantageous performance in containing the intumescent expansion. However, other materials having similar heat transfer properties may also be used.

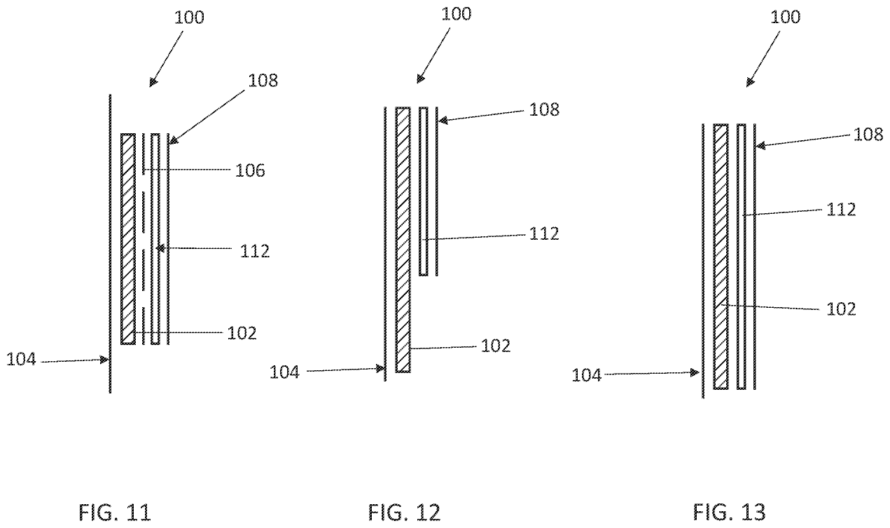

FIGS. 11-13 illustrate three different variations of fire-resistant strips 100 similar in many respects to those disclosed herein. FIG. 11 illustrates a strip 100 having, from left to right in the illustrated orientation, a protective cover layer 104, an intumescent material layer 102, an optional high heat resistant material layer 106, an adhesive layer 112, and a release paper 108. The protective cover layer 104 in the illustrated arrangement is preferably one of a woven fiberglass tape, a fiberglass chop strand mat tape, a high heat polymer tape, and a high heat foil tape. In other words, the protective cover layer 104 preferably provides a significant barrier to heat transfer. In the illustrated arrangement, the cover layer 104 is wider than the remaining layers so as to define side portions 110 of the strip 100. The side portions 110 can include an adhesive material (not separately shown) to allow the side portions 100 to be secured to the construction component, such as the overhead structure or framing member (e.g., header track 52).

FIG. 12 illustrates a strip 100 having, from left to right in the illustrated orientation, a protective cover layer 104, an intumescent material layer 102, an adhesive layer 112, and a release paper 108. Although not shown, the strip 100 could include a high heat resistant material layer 106, which can be positioned on either side of the intumescent material layer 102. The protective cover layer 104 in the illustrated arrangement is preferably one of a woven fiberglass tape, a fiberglass chop strand mat tape, a high heat polymer tape, and a high heat foil tape. In other words, the protective cover layer 104 preferably provides a significant barrier to heat transfer. In the illustrated arrangement, the protective cover layer 104 and the intumescent material layer 102 have a width that is greater than a width of the adhesive layer 112 (and the release paper 108). In some configurations, the width of the protective cover layer 104 and the intumescent material layer 102 can be less than or equal to about two-thirds or less than or equal to about one-half of the width of the adhesive layer 112. Such an arrangement allows only a portion of a total width of the strip 100 to be attached to the construction component, such as the overhead structure and/or framing member (e.g., header track 52). Preferably, in the context of a header track 52, the portion with the adhesive layer 112 is positioned relatively upward relative to the portion without the adhesive layer 112. Accordingly, an installer of the studs 54 can lift the unadhered portion of the strip 100 to insert the fasteners (e.g., metal screws) that secure the studs 54 to the header track 52. Once installed, the wallboard or drywall 56 can retain or press the unadhered portion of the strip 100 against the header track 52.

FIG. 13 illustrates a strip 100 that is similar to the strip of FIG. 12. However, all of the layers 102, 104, 106, 108, 112 are all of the same width or substantially the same width. Such an arrangement is well-suited for application after the header track 52 has been attached to the overhead structure 58 and the studs 54 have been attached to the header track 52. Thus, access to the fasteners between the header track 52 and the studs 54 is not required and the strip 100 can cover the fasteners.

The protective cover layer 104 and/or the high heat resistant material layer 106 can be a useful part of the manufacturing process wherein the layer 104, 106 can be used as a bond breaker for the intumescent material. That is, the uncured intumescent material can be poured onto the layer 104, 106 and allowed to cure. In the case of a fiberglass material layer, such as a woven fiberglass tape or a fiberglass chop strand mat tape is porous, allowing the wet intumescent mixture to penetrate the layer 104, 106 and then cure thereby securely bonding the intumescent material to the layer 104, 106. Once the intumescent is dried and cured, the layer 104, 106 creates a protective outer layer bonded to the intumescent material layer 102. In some embodiments, both layers 104, 106 are provided. The protective cover layer 104 can be an outermost or the topmost layer with the high heat resistant material layer 106 being directly adjacent the protective cover layer 104. An uncured intumescent material can be applied to the combination of the layers 104, 106 and allowed to cure. A portion of the intumescent material may penetrate the high heat resistant material layer 106 and contact the protective cover layer 104. In some embodiments, a portion of the intumescent material will create a layer 102 that is distinct from the layers 104, 106. In other words, the intumescent material will have a thickness that is greater than a thickness of the high heat resistant material layer 106. In some embodiments, the high heat resistant material layer 106 is a fiberglass material, such as a woven or nonwoven fiberglass tape.

A woven fiberglass tape includes fiberglass mat, or woven glass fibers. A chopped strand mat (CSM) is a form of reinforcement used in fiberglass. Chopped strand mat includes glass fibers laid randomly across each other and held together by a binder. The basis of textile grade glass fibers is silica, SiO2. Silica exists as a polymer in its pure form (SiO2)n. It has no actual melting point, but softens up to 2000 degrees Celsius (° C.) and begins to degrade at 1713° C. Because the fiberglass material ultimately will not burn, melt, or be consumed by the fire, it will contain the intumescent material. When intumescent material is not contained, it will expand in substantially free flow. This can lead to the intumescent falling away from the intended location of fire protection. For this reason, a fiberglass material layer can provide additional heat and fire resistance to slow down the intumescent expansion process while also containing the intumescent material safely within the drywall gap. Other suitable high heat materials can also similarly contain the intumescent material.

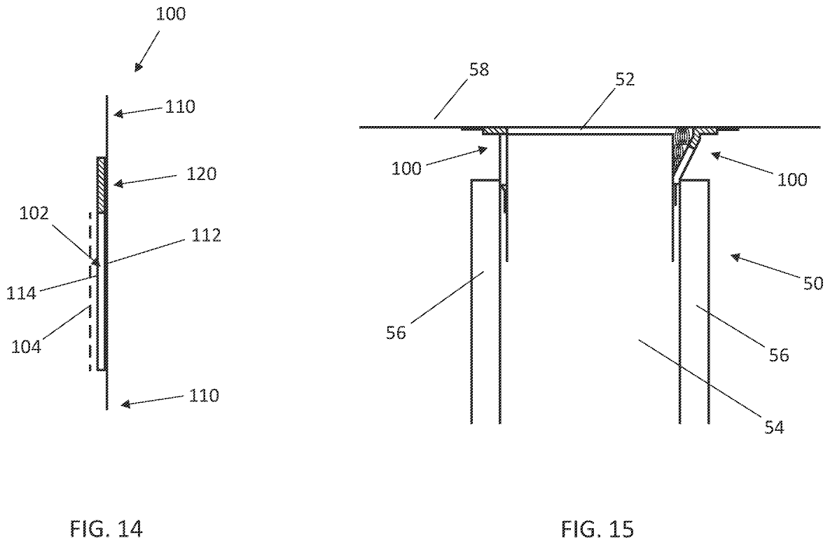

FIG. 14 illustrates another multi-layer fire-resistant tape component 100 that comprises a protective outer cover layer 104, an intumescent material layer 102, and an adhesive layer 112. In some configurations, the cover layer 104 serves several purposes. For example, the outer cover layer 104 can protect the intumescent material layer 102 from damage during shipping and construction. When introduced to elevated heat caused by fire, the outer cover layer 104 contains the intumescent expansion within the building joint. In some configurations, the outer cover layer 104 is or comprises a foil material. However, other suitable materials as discussed herein can also be used.

The strip 100 also includes an attachment layer 114 that extends beyond the intumescent strip 102, or a combination of the intumescent strip 102 and an optional foam strip 120, along the width direction of the strip 100 to create side portions 110 of the strip 100. The adhesive layer 112 preferably covers the side portions 110. The adhesive layer 112 may also cover the intumescent strip 102 and the optional foam strip 120. The foam strip 120 is located adjacent the intumescent strip 102, but in alternative arrangements could be located in a stacked arrangement with the intumescent strip 102. The adhesive layer 112 is configured to adhere to the overhead structure 58 and the framing member or the leg or flange of header track 52. In configurations in which the adhesive layer 112 is only on the side portions 110, the interior intumescent layer 102 of the strip 100 is allowed to freely float along the side flange or leg of the header track 52. This allows the intumescent layer 102 itself to be unattached to the framing member 52—except through the side portions 110 of the adhesive layer 112. In essence, the intumescent layer 102 is held in place without being directly attached thereby providing a gap or an air space between the intumescent layer 102 and the framing member 52. This air space will reduce or greatly reduce the speed in which the intumescent material of the intumescent layer 102 expands. This reduction in expansion of the intumescent layer 102 will allow the TC's that are placed directly within the building joint to remain cooler or much cooler and more importantly give it the ability to pass the UL-2079 5th edition test requirements. In some configurations, the optional foam strip 120 can be unattached to the ceiling or other horizontal or adjacent structure like the intumescent material layer 102.

FIG. 15 illustrates the strip 100 attached to a construction gap or joint, in particular, a head of wall gap. The strip 100 is shown in condition prior to expansion of the intumescent material layer 102 on the left side and after expansion of the intumescent material layer 102 has started on the right side. The intumescent material layer 102 is positioned adjacent the header track 52 and the foam strip 120, if provided, is located against the ceiling or overhead structure 58 extending in a direction away from the wall assembly 50 or away from the header track 52. The outer cover layer 104 covers the intumescent material layer 102 and optional foam strip 120 such that the intumescent material layer 102 and optional foam strip 120 are located between the header track 52 (or other structural component) and the outer cover layer 104. The transition between the intumescent material layer 102 and the foam strip 120, if provided, can be located at the change in direction of the strip 100.

In some configurations, the outer cover layer 104 is slightly elastic or stretchable to be able to stretch and grow as the intumescent expands. As described above, in some configurations the outer cover layer 104 can have heat resistant properties and can comprise the high heat resistant materials described herein. In some configurations, the outer cover layer 104 can also be a paintable material for exposed building joints. In some configurations, the outer cover layer 104 can also include or be made from, or an additional layer(s) can be provided that includes or are made from, a material that can properly receive joint compound without cracking the joint compound. Suitable materials include fiberglass tape, paper tape, or fabric tape. The foam layer 120 can be an open or a closed cell material, compressible and/or of varying thicknesses, with or without adhesive backing.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A fire-resistant strip for providing a fire-rated seal to a construction gap or joint, comprising:
an intumescent material layer configured to expand in response to a temperature above an expansion threshold temperature;
at least one heat resistant material layer made of or comprising an uncoated fiberglass material having a melting temperature above the expansion threshold temperature of the intumescent material, wherein the at least one heat resistant material layer covers the intumescent material layer;
at least one adhesive layer configured to secure the fire-resistant strip to a building structure or structures defining the construction gap or joint.

2. The fire-resistant strip of claim 1, wherein the at least one heat resistant material layer comprises a first heat resistant material layer and a second heat resistant material layer.

3. The fire-resistant strip of claim 2, wherein the intumescent material layer is positioned between the first heat resistant material layer and the second heat resistant material layer.

4. The fire-resistant strip of claim 1, wherein the at least one heat resistant material layer comprises a woven fiberglass material, a fiberglass mat, or a fiberglass chop strand mat material.

5. The fire-resistant strip of claim 1, further comprising a cover layer made of or comprising foil, vinyl or fiberglass.

6. The fire-resistant strip of claim 5, wherein the cover layer and/or the at least one heat resistant material layer is wider than the intumescent layer to form side portions of the fire-resistant strip.

7. The fire-resistant strip of claim 6, wherein the side portions include adhesive.

8. The fire-resistant strip of claim 5, wherein the intumescent material layer is positioned between the cover layer and the at least one heat resistant material layer.

9. The fire-resistant strip of claim 1, wherein the adhesive layer is a double-sided foam or adhesive film tape.

10. The fire-resistant strip of claim 1, wherein the at least one heat resistant material layer is wider than the intumescent layer to form side portions of the fire-resistant strip.

11. The fire-resistant strip of claim 1, wherein the at least one adhesive layer has a width that is equal to or less than a width of one or both of the intumescent material layer and the at least one heat resistant material.

12. The fire-resistant strip of claim 11, wherein the width of the at least one adhesive layer is equal to or less than two-thirds of the width of one or both of the intumescent material layer and the at least one heat resistant material.

13. The fire-resistant strip of claim 11, wherein the width of the at least one adhesive layer is equal to or less than one-half of the width of one or both of the intumescent material layer and the at least one heat resistant material.
